(19) United States
(12) Patent Application Publication
(10) Pub. No.: US 2006/0169640 A1
(43) Pub. Date: Aug. 3, 2006

(54) High throughput screening, purification and recovery system for large and small molecules

(76) Inventor: Hubert Quinn, Brighton, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/048,335

(22) Filed: Feb. 1, 2005

(51) Int. Cl. B01D 15/08

(52) U.S. Cl. 210/656; 436/161; 436/178

(57) ABSTRACT

The present invention relates to a method and apparatus for chromatographically analyzing/purifying samples in a detector, comprising an autosampler to contain a sample for chromatographic analysis and a chromatographic system comprising a loading pump, and an eluting pump and at least one chromatography column. A detector is included for detecting compounds in the sample from the chromatography system. The loading pump establishes a flow of a loading solvent through the autosampler to dissolve the sample and to load the sample on the chromatography column. The eluting pump establishes a flow of eluent of increasing strength through the column and to the detector. In addition, the present invention provides improved methods of screening and preparative chromatography.

### FIELD OF THE INVENTION

The present invention relates to a high throughput purification and recovery system for large and small molecules, particularly suitable for high performance liquid chromatography (HPLC). The invention also relates to an improved technique in connection with screening and preparative chromatography methods.

### BACKGROUND OF THE INVENTION

Combinatorial chemistry is a drug discovery technology being employed by pharmaceutical companies worldwide. Through combinatorial chemistry, a strategy of diversity is used to synthesize as many different molecules as possible and test their reaction to a specific “target”, such as a disease or cell structure. Screening is the chemical assay of the molecules with the “target”. If any of the molecule(s) show some reaction to the “target” during screening, the molecule(s) become a candidate for a commercial drug. The candidate molecule(s) are then characterized to determine both their composition and structure to enable additional synthesis and testing.

The ability of combinatorial chemistry to rapidly produce such a large number of different compounds has created a need for new methods of screening compound libraries. Techniques developed for screening individually synthesized compounds to identify those compounds having a desired reaction to a specific target are not practical for handling the products of combinatorial synthesis. Traditional approaches to screening are too slow and expensive to keep up with the rapid generation of compounds by combinatorial synthesis.

### SUMMARY

In a first embodiment, the present invention relates to a method of chromatographically analyzing/purifying a sample dissolved in a dipolar aprotic solvent or mixture of solvents having a polarity index greater than about 4.0, providing a sample wherein said sample comprises one or a plurality of solutes, dissolving said sample in said solvent, providing a chromatography column and loading said sample on said column with a loading solvent, establishing a flow of eluent of increasing strength through said chromatography column and introducing said effluent exiting said chromatography column to a detector.

In a second embodiment the present invention relates to a method for screening and purifying one or a plurality of samples comprising providing a dipolar aprotic loading solvent or mixture of solvents having a polarity index greater than about 4.0, dissolving said sample in said loading solvent, wherein said sample comprises one or a plurality of solutes, loading said sample on a first chromatography column with said loading solvent, identifying a generic eluent system to elute said one or plurality of solutes in said sample on said first column, and establishing a flow of said generic eluent system through said first chromatography column. This may be followed by the step of introducing the generic eluent system exiting said first chromatography column to a detector and detecting said one or plurality of solutes in said sample and optimizing said generic eluent system with respect to at least one of said plurality of solutes detected in said sample to provide an optimized eluent system relative to said generic eluent system. This may then be followed by providing a second column for purifying and/or recovering said at least one of said plurality of solutes in said sample in said second column with said optimized eluent system.

In a third embodiment the present invention relates to a method for screening and purifying a sample containing one or a plurality of solutes comprising establishing a flow of an eluent system containing organic solvent in a first column and detecting and collecting an eluent fraction containing at least one of said plurality of solutes. This may be followed by diluting on-line said eluent fraction containing at least one of said plurality of solutes with water while maintaining the solubility of said at least one of plurality of solutes and transferring said diluted eluent fraction onto a second column containing a stationary phase for purifying/recovering said at least one of said plurality of solutes in said sample in said second column wherein said at least one of said plurality of solutes is initially bound to the stationary phase. This may be followed by eluting said second column with organic based eluent wherein said organic based eluent comprises organic solvent at a level of greater than 50% (vol).

### BRIEF DESCRIPTION OF THE DRAWINGS

Features and advantages of the present invention will be apparent from the detailed description of embodiments consistent with the present invention, which description should be considered in conjunction with the accompanying drawings, wherein:

FIG. 1 illustrates in schematic view an exemplary liquid chromatography system consistent with the present invention.

FIG. 2 illustrates the screening and purification method applicable to the present invention.

### DETAILED DESCRIPTION

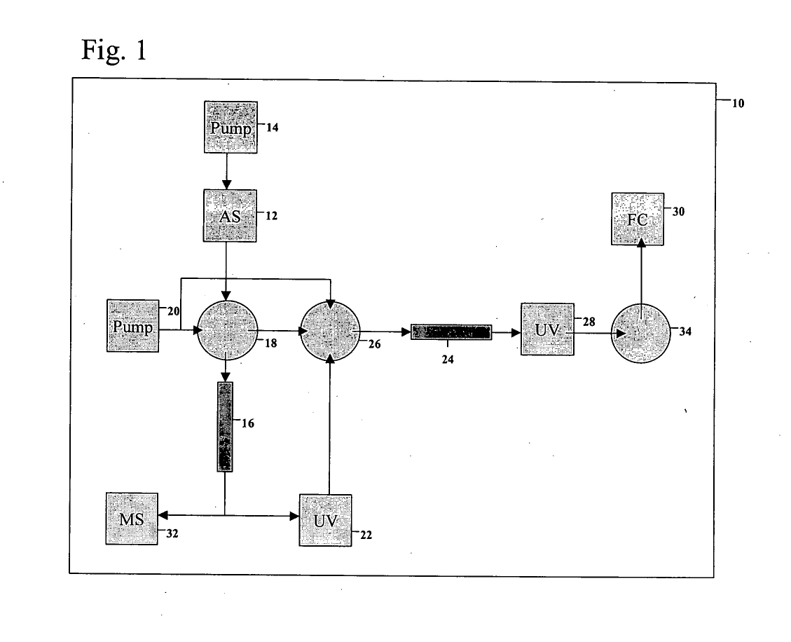

An embodiment of a chromatography system 10 consistent with the present invention is shown in schematic view in FIG. 1. As shown in the schematic illustration, the system 10 may include an autosampler 12, containing at least one sample for chromatographic analysis/purification, and a first pump 14, such as an agilent 1100 series model G1361A or G1312A, for providing means for loading a sample held by the autosampler 12. The system 10 may further include a first multi-port valve 18 for selectively passing a sample from the autosampler 12 to a first separation column 16. A second pump 20 may independently establish a flow of solvent, that is, a mobile phase component used to carry out dilution/mixing of the sample in the carrier mobile phase before entering the separation column 16 via the first multi-port valve 18. The system 10 may include a first detector 22 for identifying fractions/sample components of the effluent isolated or separated by column 16. Detector 22 may be a non-specific detector such as a UV detector and may be used in conjunction with a specific detector such as a Mass Spectrometer 32.

A second multi-port valve 26 may be provided for directing effluent from the first multi-port valve 18 or from the first detector 22 to a second recovery/concentration column 24. A sample component eluted from the second column 24 may be directed to a second detector 28. The system 10 may further include a third multiport valve 34 to direct eluent fraction(s) to a fraction collector 30 for receiving separated portions of the effluent exiting the second detector 28.

Both the first pump 14 and the second pump 20 may be high pressure binary pumps. As noted, the first pump 14 may be devoted to loading the column with a sample and the second pump 20 may be devoted to both loading and elution. As such, the first pump 14 may establish a flow of a loading solvent into the separation column 16 via the autosampler 12 and first valve 18. The second pump 20 may be adapted to provide a flow of an eluent having a variable strength. Providing a flow of eluent having variable strength may be accomplished, for example, by combining a primary eluent with a diluent, e.g., additional liquid components. Desirably the concentration of the eluent fluid in the mobile phase may be controlled either dynamically or according to a predetermined scheme.

The first separation column 16 and second column 24 may comprise a wide variety of columns suitable for use in the field of chromatography. For example, the columns 16, 24 may include high performance liquid chromatography (HPLC) columns, capillary electrophoresis columns, flow injection transfer lines, etc.

One particularly preferred variety of chromatography column herein, but by no means limiting, are those columns which include a substantially uniformly distributed multiplicity of rigid, solid, porous/pellicular particles with chromatographically active surfaces. The particles may have average diameters greater than about 30 μm, with the interstitial volume between the particles being not less than about 45% of the total volume of said column. The column may further include a means for loading the surface of the particles with at least one solute molecule that is reactive with the surfaces, by flowing a liquid mixture containing a loading solvent and the solute into said body, and flowing an eluent through said body at a velocity sufficient to induce flow of the eluent and solute within at least a substantial portion of the interstitial volume at a reduced velocity greater than about 5000.

The detectors 22, 28 and 32 may also include any of several varieties of detectors that are suitable for use with chromatography systems to detect the samples eluted through the columns. Suitable detectors for use with the system 10 herein may utilize identification systems including mass spectrometry, UV spectra, NMR, ELS (evaporative light scattering), refractive index, and fluorescence. The detector therefore provides identification/quantitation of the desired component compounds of a sample by determining exactly when such a desired component compound is eluted from the exit end of the column. Those having skill in the art will appreciate that other similar systems for identifying eluted compounds may also be employed.

According to another aspect, the present invention provides a method of separating a mixture of many different compounds or solute molecules. For example, consistent with the method herein products of combinatorial synthesis may be detected, purified and recovered. It should be appreciated that while the method herein is suitable for separating a sample containing as few as two different compounds, the method herein provides special advantage for separating mixtures of numerous solute molecules.

As a general overview, a sample may be dissolved in a given solvent and combined with a loading solvent capable of dissolving all of the compounds in the sample mixture. The solute sample may then be loaded on a chromatography column using the loading solvent as a transfer medium. The loading solvent is then removed/depleted from the column, which can be accomplished by flushing with water or combinations thereof. The chromatography column may then be eluted with eluent fluids of increasing strength. Eluted fractions separated by the chromatography column may be directed into a detector and characterized thereby. According to further embodiments, the separated fractions, or selected fractions, may be recovered. Accordingly, the method herein may not only provide screening of the sample mixture, but may also allow for the concentration and recovery of the separated components. In this regard, an additional and second concentration chromatography column may be used to further purify or concentrate the eluted fractions to be recovered.

As used in connection with any embodiment herein, the strength of an eluent is a relative measure of the ability of an eluent to elute a particular solute or compound from the stationary phase of a chromatography system. Generally, a stronger eluent may be suitable for use with sample components that are more strongly retained chromatographically, i.e., fraction that exhibit a strong affinity for, or interaction with, the stationary phase. However, compounds having a weaker affinity or interaction with the stationary phase, i.e., that are less chromatographically reactive, may be overwhelmed by a strong eluent resulting in inadequate separation of the compounds in a chromatography sample. The factors determining eluent strength may be related to the type of separation column employed and the chromatography technique utilized. In one embodiment, eluent strength may be a relative measure of the polarity of the fluid.

Therefore, in the context of the present invention, a mixture containing a number of different organic compounds may be dissolved, using a given solvent, which may be different from the loading solvent. The mixture of compounds dissolved in said solvent and when combined with the loading solvent may be referred to as a “solute mixture” herein. As used in any embodiment herein, a loading solvent is defined as a dipolar aprotic solvent having a polarity index greater than about 4.0. In a further embodiment, the loading solvent may be a dipolar aprotic solvent having a polarity index greater than about 5.0. In still a further embodiment, the loading solvent may be a dipolar aprotic solvent having a polarity index greater than about 6.0. According to yet another embodiment, the loading solvent may be a dipolar aprotic solvent having a polarity index greater than about 6.5. In addition, the present invention relates to the use of dipolar aprotic loading solvents, including mixtures of solvents, that provide a polarity index of between about 4.0-10.0, including all values and ranges therebetween. Several additional solvents having a polarity index greater than 4.0 are listed in Table 1 below.

The loading solvent may therefore be selected for its ability to fully dissolve/dilute all of the compounds in the mixture. The polarity indices of a variety of solvents may be found, e.g., in “High Purity Solvent Guide”, Burdick and Jackson Laboratories, Inc., distributed by American Scientific Products. In the case of mixtures prepared by combinatorial chemistry, a large number of compounds having diverse chemical characteristics may be included in the mixture. A particular solvent, such as a sulphone solvent such as dimethyl sulfoxide, may be especially suitable for dissolving a wide variety of compounds. Other examples of suitable solvents may include, but are not limited to, dimethylformamide, dimethylacetamide, methanol, acetonitrile, and tetrahydrofuran.

TABLE 1
Solvent Characteristics.

| | Polarity | Dipole | Dielectric | Boiling | Freezing |
|---|---|---|---|---|---|
| Solvent | Index | moment | Constant | Point | Point |
| n-Butyl Acetate | 4.0 | 1.84 | 5.01 | 126.1 | −73.5 |
| n-Propyl Alcohol | 4.0 | 3.09 | 20.33 | 97.2 | −126.2 |
| Tetrahydrofuran | 4.0 | 1.75 | 7.58 | 66 | −108.5 |
| Chloroform | 4.1 | 1.15 | 4.81 | 61.1 | −63.5 |
| Ethyl Acetate | 4.4 | 1.88 | 6.02 | 77.1 | −84.0 |
| Ethyl Methyl | 4.7 | 2.76 | 18.51 | 79.6 | −86.7 |
| Ketone | | | | | |
| 1,4-Dioxane | 4.8 | 0.45 | 2.25 | 101.3 | 11.8 |
| Acetone | 5.1 | 2.69 | 20.7 | 56.3 | −94.7 |
| Methanol | 5.1 | 2.87 | 32.70 | 64.7 | −97.7 |
| Pyridine | 5.3 | 2.37 | 12.4 | 115.2 | −41.5 |
| 2-MethoxyEthanol | 5.5 | 2.04 | 16.93 | 124.6 | −85.1 |
| Acetonitrile | 5.8 | 3.44 | 37.5 | 81.6 | −43.8 |
| N,N- | 6.4 | 3.86 | 36.71 | 153.0 | −60.4 |
| DimethylFormamide | | | | | |
| DimethylAcetamide | 6.5 | 3.72 | 37.78 | 166.1 | −20 |
| N- | 6.7 | 4.09 | 32.2 | 202 | −24.4 |
| MethylPyrrolidone | | | | | |
| Dimethyl Sulfoxide | 7.2 | 4.1 | 46.68 | 189 | 18.5 |
| Water | 10.2 | 1.87 | 80.1 | 100.0 | 0.0 |

The solution including dimethyl sulfoxide and solute mixture may therefore facilitate the transfer of the mixture of compounds to a chromatography column. Dimethyl sulfoxide is preferably used to dissolve the mixture and, in combination with the loading solvent, load the mixture on the chromatography column by providing a medium that will carry, i.e., dissolve all of the compounds in the mixture. While dimethyl sulfoxide is one solvent suitable for dissolving a diverse array of chemical compounds, dimethyl sulfoxide is such a solvent that it may not be a suitable eluting solvent. A solvent as aggressive as dimethyl sulfoxide may overwhelm the chromatographic reactivity between at least some of the solute components and the stationary phase. Rather than separating the various compounds in the solute mixture, dimethyl sulfoxide may simply wash the solute mixture through the chromatography column with little or no separation of the components of the solute mixture. Accordingly, once loaded onto the column with a solvent such as DMSO, it is preferable to remove/deplete the DMSO from the column prior to elution.

Eluent fluids that are used to elute the solute mixture loaded on the chromatography column may be selected based on the ability to separate the compounds of the solute mixture as the solvent is eluted through the column. A mixture including numerous different compounds may include compounds that present a broad range of chromatographic reaction strengths with the stationary phase of a chromatography column. Accordingly one eluent may not be suitable for separating all of the fractions. For example, fractions exhibiting a weak chromatographic reaction with the stationary phase may be overwhelmed by a relatively strong eluent, and may a not fully separate. Similarly, fractions exhibiting a strong chromatographic reaction with the stationary phase may not elute at all. The column may, therefore, be eluted with eluents of different strengths that will elute different fraction from the solute mixture.

In one embodiment, the column may be sequentially eluted with eluents of increasing strength. A first eluent, having a relatively low strength, may be used to elute those compounds in the solute mixture that have the weakest chromatographic reactivity with the stationary phase. The fraction(s) eluted with the first, relatively low strength, eluent may be separated according to conventional principles of chromatography. The compounds of the solute mixture exhibiting stronger chromatographic reactivity with the stationary phase may not be eluted by the first eluent, and may remain in the column. As the separated fractions are eluted they may be identified using a variety of detection systems. For example, the separated fraction may be identified using mass spectrometry, UV, refractive index, NMR, fluorescence, as well as various other identification techniques known to those having skill in the art.

After a first group of compounds have been eluted using the first eluent, the column may be eluted with a second eluent. The second eluent may be stronger than the first eluent. The stronger character may allow the second eluent to elute a second group of compounds from the solute mixture loaded on the column. The second group of compounds may have a stronger chromatographic reactivity with the stationary phase than the first group of compounds. As with the compounds eluted with the first eluent, the second group of compounds may be separated according to the conventional principles of chromatography using the second eluent. Also as with the first elution, compounds having stronger chromatographic reactivity with the stationary phase may not be eluted, and may remain in the column. The separated fractions of the second group may be identified by a suitable detection method as the compounds are eluted.

The chromatography column may be sequentially eluted with progressively stronger eluents until all of the compounds from the solute mixture have been eluted. With each increasingly stronger eluent a group of one or more compounds may be eluted from the solute mixture loaded on the column. Each group of eluted compounds may be separated and identified in the same manner as described with reference to the first and second group of compounds. Sequentially eluting the column with progressively stronger eluent may be carried out as a continuous process. After a desired volume of the first eluent (or elution time) has been introduced, the second eluent may be introduced to the column without disrupting the flow of the mobile phase.

According to one specific embodiment, the eluents used to elute the solute mixture loaded on the column may include a mixture of eluent fluids in which the ratio of components in the mixture is varied to achieve different strengths. For example, a blend of eluents including a relatively stronger component and a relatively weaker component may be used as the mobile phase. The proportion of the relatively stronger eluent to the relatively weaker eluent may be varied to provide a mobile phase of different strengths. Additionally, the same eluent or blend of eluents may be mixed with a diluting component. The concentration of the diluting component may be varied to control the overall strength of the eluent.

In one embodiment, rather than eluting the column with a plurality of eluents, the column may be eluted with a mobile phase of continually increasing strength. For example, the eluent may be a mixture including a strong eluent and a weak eluent. The ratio of the strong eluent and the weak eluent may be varied during the course of the elution. Initially, the ratio of the strong eluent to the weak eluent may be low, thereby providing a relatively weak eluting phase. The strength of the eluent may be increased in a step-wise manner to effect sequential elution with progressively stronger eluents. According to another embodiment, the strength of the eluent may be continuously increased, thereby providing gradient eluent strength. The ratio of the strong eluent to the weak eluent may be increased at a predetermined rate during the separation. The rate at which the strength of the eluent is increased may be constant throughout the separation. Alternatively, the rate at which the strength of the eluent is increased may be varied one or more times during the course of the separation. Generally, the rate of increase of the strength of the eluent may be selected to allow sufficient separation of the fractions for identification and/or isolation of the molecules.

Accordingly, in the broad context of the present invention, one may dissolve a sample in a load solvent, load the sample onto the column, remove the loading solvent, and identify what is characterized herein as a generic eluent system to elute the plurality of molecules in the sample. This may be accomplished by selecting an eluent system for the plurality of molecules and detecting whether or not such eluent system causes any of the molecules to precipitate in the column, and in the event that the selected eluent system results in precipitation, selecting another eluent system and repeating until a generic eluent system which avoids precipitation is identified.

With reference to the exemplary system 10 illustrated in FIG. 1, the loading pump 14 may supply a suitable loading solvent, to load a sample dissolved in a suitable solvent such as dimethyl sulfoxide disposed in the autosampler 12. The dissolved sample may then be loaded on the separation column 16, via the first multi-port valve 18, by the loading pump 14. The eluting pump 20 may provide a flow of eluent through the separation column 16, wherein the eluent is of a predetermined strength. Effluent from the separation column 16 may be directed to the first detector 22. The detector 22 may identify the compounds of each fraction as they are eluted. From the first detector 22, the effluent may pass through a second multi-port valve 26 and a second purification column 24. A second detector 28 may be used to further characterize eluted compounds, to verify the identification of the compounds. The effluent from the column 24 may be directed to the fraction collector 30 via the multiport valve 34. Based on the response by the second detector 28, individual fractions eluted from the concentration column may be separately collected. Accordingly, not only may the system of the present invention be used to identify the compounds produced by a combinatorial synthesis, but may also be used to separate the various compounds and selectively recover individual or specific compounds.

It will be understood by those having skill in the art that the invention herein may be suitable for various modes of chromatography including normal phase, reverse phase, ion-exchange chromatography and the like. According to one embodiment, a mixture of compounds may be separated consistent with the present invention using both normal phase and reverse phase chromatography. Chromatographically separating a mixture of compounds using both normal phase and reverse phase chromatography may be used, for example, to separate optical isomers.

In connection with the above, as previously noted, the present invention also provides a method of chromatographically analyzing and purifying one or a plurality of molecules, such as a collection of molecules of pharmaceutical interest. Expanding on this point, this would include the screening and purification of libraries of relatively small molecules of pharmaceutical interest, and of biological molecules such as polypeptides, proteins, oligonucleotides and deoxyribonucleic acid (DNA) polymers.

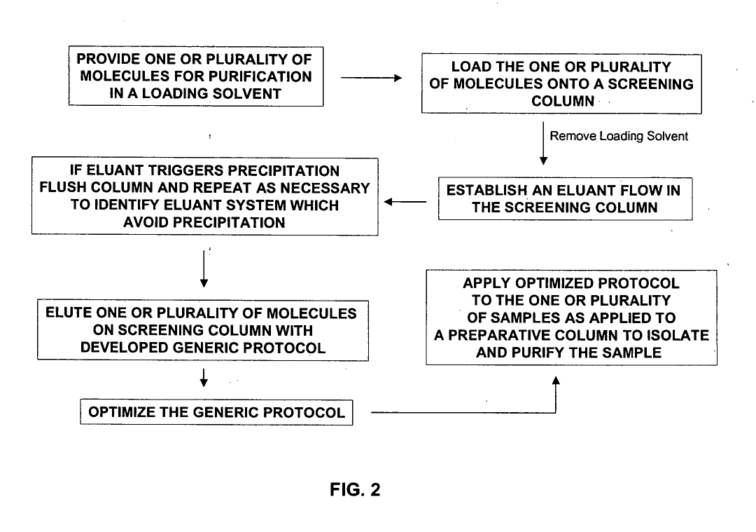

FIG. 2 illustrates the screening and purification method available in the present invention. The method herein comprises the steps of loading a sample contain one or plurality of molecules onto a first screening column with the loading solvent of the present invention. This is followed by removing/depleting the loading solvent from the column and establishing an eluent flow in the screening column. In the event that eluent triggers precipitation of the one or plurality of molecules in the column, the column is then flushed and the process is repeated as necessary to identify an eluent system which would avoid precipitation. Accordingly, once such an eluent system is identified, it is, as noted above, defined herein as the generic eluent system upon which one may elute the one or plurality of molecules.

The generic eluent system is then optimized with respect to at least one of a plurality of molecules detected in the sample to provide an optimized eluent system relative to the generic eluent system. In the context of the present invention this step of optimizing should be understood as identifying an eluent system which enhances, relative to the generic eluent system, the chromatographic separation of at least one of the plurality of molecules in the sample with respect to other molecules in the sample. For example, the generic eluent system once identified may provide a complete separation of a plurality of molecules to be detected over a selected time period, e.g., a time period of 540 seconds (9 minutes). Then, in accordance with the present invention one of the peaks corresponding to a molecule of interest is selected and the optimized eluent system ensures that said peak will have improved isolation and better separation from the other peaks in the sample which other peaks correspond to the other molecules in the sample that are not of interest. Accordingly, wherein the generic eluent system provided multiple peak outputs over the selected time period of 540 seconds, the optimized eluent system may then only elute and detect the peak of interest in the range of 450-540 seconds. Of course, those skilled in the art will recognize that such retention time for elution may be altered and accommodated to other retention times, which is all within the broad concept of optimization of the eluent system that is disclosed herein.

As previously noted, one particularly preferred variety of chromatography columns herein, but by no means limiting, are those columns which include a substantially uniformly distributed multiplicity of rigid, solid, porous/pellicular particles with chromatographically active surfaces. The particles may have average diameters greater than about 30 μm, with the interstitial volume between the particles being not less than about 45% of the total volume of said column. The column may further include a means for loading the surface of the particles with at least one solute that is reactive with the surfaces, by flowing a liquid mixture containing a loading solvent and the solute into said body, and flowing and eluent through said body at a velocity sufficient to induce flow of the eluent and solute within at least a substantial portion of the interstitial volume at a reduced velocity greater than about 5000. To these ends, one aspect of the present invention is directed to the use of a chromatography column or body in the chromatography system herein that is formed as a substantially uniformly distributed multiplicity of rigid, solid, porous particles having substantially uniform mean cross-section dimensions or diameters of not less than about 30 μm, typically 50 μm or greater up to, but not limited to, 1000 μm in certain instances as will be delineated hereinafter. The term “particle” as used herein should not be construed as limited to any particular form or shape, regardless of symmetry or lack thereof, aspect ratio, regularity and the like. The term “solid” as used herein, is intended to refer to the physical state of the matter and should not be construed to exclude porous particles. The particles are selected from a range of various sizes and shapes and are held together in a body or column as by pressure, sintering and the like so that interstitial channels having a total interstitial volume of not less than about 45% of the total volume of the column are formed between the particles. The surfaces of the particles, including the inner surfaces of any pores in the particles, may be chromatographically active, as by being coated with chromatographic stationary phase layers. The method herein includes the step of flowing into the column a fluid mixture containing a loading solvent that has, and at least one solute or suspended phase that is interactive with the particles' surfaces in order to load the column. The method further includes flowing through the column an eluting fluid. Because of the nature of the particles and packing in the column, the flow of the eluting fluid through the column can be at a high flow rate, preferably at an average reduced velocity (i.e., ud[p]/D wherein “u” is the mobile phase velocity, “d[p]” is the packing particle diameter and “D” is the diffusion coefficient in the mobile phase) greater than about 5000, and including, in certain instances to be described hereinafter, reduced velocity values as high as 70,000 or higher. It is believed that under such conditions, turbulent flow of the mixture is induced within at least a major portion of the interstitial volume, and it is postulated that such turbulent flow in fact enhances the rate of mass transfer, thus increasing the dynamic capacity of the column.

The particles described above are preferably formed from materials that are incompressible, which term is to be understood to mean that the time rate of changes of the densities and volumes of the particles under pressures of at least about 5×10³ psi, (including outlet column frit retainer) remains substantially zero, and the particles therefore will substantially resist plastic deformation even at such high pressure. The particles are shaped and selected in a range of sizes and shapes such that they can be packed at a pressure sufficient to form a column characterized in having interstitial channels formed between the particles. Because of the irregularity of the particles, it will be recognized that the interior walls of such channels are necessarily quite rough in configuration. While it is believed that at least the majority of channels have mean cross-section diameters substantially not less than about 4 μm, the interstitial volume fraction (i.e., the total volume of interstitial channels between the particles) should not be less than about 45% of the total volume of the column. It will be appreciated that typical columns have interstitial volume fractions less than about 45%, more particularly ranging from about 35% to 42%. The surfaces of particles are chromatographically active either per se as is well known in the art, or by treatment, as by coating, with any of the many known chromatographically active, stationary phase layers, also as well known in the art.

As noted, in order to insure the formation of the desired uniform density column with the preferred interstitial fraction and to preclude collapse under operating pressure, the particles used to pack a column for use in the present invention of chromatography analysis may include rigid solids that must necessarily be incompressible at packing pressure of at least about 5×10³ psi, preferably up to pressures as high as about 1×10⁴ psi. To that end, the preferred particles are formed from materials such as alumina, titania, silica, zirconia, vanadia, carbon, various relatively inert metals, and combinations thereof.

In that regard, the chromatography column used herein may include columns used under conventional laminar flow regimes. The columns may therefore be constructed of particles, which due to a lack of requisite rigidity are run at low flow rates and pressure drops. Such particles may have average particle sizes less than about 30 microns and as small as about 1 micron. It is understood that under these operating conditions, the analysis times are relatively long and the reduced velocities may be as small as 1.

In addition, the invention herein may include the use of a substantially uniform, elongated chromatography column containing chromatographically reactive surfaces, means for injecting into said column a discrete volume of liquid mixture containing a loading solvent and at least one solute that is reactive with said surfaces so as to load said column, and a means for flowing an eluent fluid through said loaded column, wherein the means for flowing said eluent fluid comprises means for injecting at least one discrete plug of said eluent fluid into said column adjacent the input of said column so as to maintain minimized spatial step separation between said plug and said discrete volume of liquid mixture as said plug and volume traverse the column wherein said column and said means for flowing are configured such that the flow of said volume of eluent traverses said column at a reduced velocity greater than about 5000.

The invention herein is also applicable to chromatography columns having chromatographically reactive surfaces, including the steps of flowing through said column a discrete volume of a liquid mixture containing a loading solvent and at least one solute that is reactive with said surfaces, and eluting from said surfaces said solute bound thereto, by flowing an eluent fluid through said column, comprising the steps of injecting at least one discrete volume of an eluent fluid into the flowstream in said column such as to maintain minimized spatial separation between said discrete volumes as the latter traverse said column at a reduced velocity great than about 5,000.

It should be understood that the description of embodiments herein is intended for the purpose of illustration. The disclosure is susceptible to modification and variation without departing from the present invention and should not be construed as limiting the scope of the invention as defined by the claims appended hereto.

What is claimed is:

1. A method of chromatographically analyzing a sample comprising:
providing a dipolar aprotic loading solvent or mixture of solvents having a polarity index greater than about 4.0;
providing a sample wherein said sample comprises one or a plurality of molecules;
dissolving said sample in said loading solvent;
providing a chromatography column and loading said sample on said column with said loading solvent;
establishing a flow of eluent of increasing strength through said chromatography column; and
introducing said effluent exiting said chromatography column to a detector.

2. The method according to claim 1 wherein said loading solvent comprises a dipolar aprotic solvent or mixture of dipolar aprotic solvents having a polarity index between about 4.0-10.0.

3. The method according to claim 1 wherein said loading solvent comprises dimethyl sulfoxide (DMSO).

4. The method according to claim 1, wherein prior to establishing a flow of eluant through said column, the loading solvent is substantially removed from said column.

5. The method of claim 4 wherein said loading solvent is removed from said column by flushing said column with water.

6. The method according to claim 1 wherein establishing a flow of eluent comprises establishing a flow of eluent having sequentially increasing strength.

7. The method of claim 6, wherein establishing a flow of eluent of sequentially increasing strength comprises supplying an water/organic solvent component combination and increasing the concentration of organic solvent relative to the water component.

9. The method according to claim 1 wherein said chromatography column is packed with a substantially uniformly distributed multiplicity of rigid, solid, porous particles with chromatographically active surfaces, so as to form a chromatography column having an interstitial volume between said particles, said particles having average diameters of not less than about 30 μm; and loading said surfaces with at least one molecule that is reactive with said surfaces, by flowing said sample dissolved in said loading solvent into said column and flowing said eluent through said column at a velocity sufficient to induce flow of said eluent within at least a substantial portion of said interstitial volume at a reduced velocity greater than about 5,000.

10. The method of claim 1 further including the steps of providing an autosampler containing at least one sample for analysis, selecting a sample for analysis from said autosampler, providing a loading pump to establish a flow of loading solvent through said autosampler and into said column, and providing an eluting pump to establish said flow of eluent in said column.

11. A method for screening one or a plurality of molecules comprising:
providing a dipolar aprotic loading solvent or mixture of solvents having a polarity index greater than about 4.0;
dissolving said sample in said loading solvent, wherein said sample comprises one or a plurality of molecules;
loading said sample on a first chromatography column with said loading solvent;
identifying a generic eluent system to elute said one or plurality of molecules in said sample;
establishing a flow of said generic eluent system through said chromatography column; and
introducing effluent exiting said chromatography column to a detector and detecting said one or plurality of molecules in said sample.

12. The method of claim 11 wherein said step of identifying a generic eluent system to elute said one or plurality of molecules comprises:
selecting an eluent system for said one or plurality of molecules;
detecting whether or not said eluent system for said one or plurality of molecules causes any of said molecules to precipitate in said column and in the event that said selected eluent system results in precipitation of any one or plurality of molecules in said column, selecting another eluent system and repeating until a generic eluent system which avoids precipitation is identified.

13. The method according to claim 11 wherein said chromatography column is packed with a substantially uniformly distributed multiplicity of rigid, solid, porous particles with chromatographically active surfaces, so as to form a chromatography column having an interstitial volume between said particles, said particles having average diameters of not less than about 30 μm; and loading said surfaces with at least one solute that is reactive with said surfaces, by flowing said sample dissolved in said loading solvent into said column and flowing said eluent through said column at a velocity sufficient to induce flow of said eluent within at least a substantial portion of said interstitial volume at a reduced velocity greater than about 5,000.

14. A method for screening and/or purifying one or a plurality of molecules comprising:
providing a dipolar aprotic loading solvent or mixture of solvents having a polarity index greater than about 4.0;
dissolving said sample in said loading solvent, wherein said sample comprises one or a plurality of molecules;
loading said sample on a first chromatography column with said loading solvent;
identifying a generic eluent system to elute said one or plurality of molecules in said sample on said first column;
establishing a flow of said generic eluent system through said first chromatography column; and
introducing said generic eluent system exiting said first chromatography column to a detector and detecting said one or plurality of molecules in said sample;
optimizing said generic eluent system with respect to at least one of said plurality of molecules detected in said sample to provide an optimized eluent system relative to said generic eluent system;
providing a second column for purifying and purifying said at least one of said plurality of molecules in said sample in said second column with said optimized eluent system.

15. The method of claim 14 wherein said generic eluent system to elute said sample comprises eluting said sample over a selected retention time period in said first column and detecting said one or plurality of molecules in said sample.

16. The method of claim 15 wherein said step of optimizing said generic eluent system with respect to at least one of said plurality of molecules in said sample comprises identifying an eluent system which enhances, relative to the generic eluent system, the chromatographic separation of at least one of said plurality of molecules in said sample with respect to other molecules in said sample.

17. The method of claim 14 wherein said step of purifying said at least one of a plurality of molecules comprises detecting said one of a plurality of molecules and recovering as a fraction in said optimized eluent system subsequent to elution through said second column.

18. The method of claim 14 wherein said first column is packed with a substantially uniformly distributed multiplicity of rigid, solid, porous particles with chromatographically active surfaces, so as to form a chromatography column having an interstitial volume between said particles, said particles having average diameters of not less than about 30 μm; and loading said surfaces with at least one molecule that is reactive with said surfaces, by flowing said sample dissolved in said loading solvent into said column and flowing said generic eluent system through said column at a velocity sufficient to induce flow of said eluent within at least a substantial portion of said interstitial volume at a reduced velocity greater than about 5,000.

19. The method of claim 14 wherein said second column is packed with a substantially uniformly distributed multiplicity of rigid, solid, porous particles with chromatographically active surfaces, so as to form a chromatography column having an interstitial volume between said particles, said particles having average diameters of not less than about 30 μm; and loading said surfaces with at least one molecule that is reactive with said surfaces and flowing said optimized eluent system through said column at a velocity sufficient to induce flow of said eluent within at least a substantial portion of said interstitial volume at a reduced velocity greater than about 5,000.

20. The method of claim 14 wherein said first and second column are packed with a substantially uniformly distributed multiplicity of rigid, solid, porous particles with chromatographically active surfaces, so as to form chromatography columns having an interstitial volume between said particles, said particles having average diameters of not less than about 30 μm; and loading said surfaces with at least one molecule that is reactive with said surfaces and flowing said generic eluent and/or optimized eluent system through said columns at a velocity sufficient to induce flow of said eluent within at least a substantial portion of said interstitial volume at a reduced velocity greater than about 5,000.

21. A method for screening and purifying a sample containing one or a plurality of molecules comprising establishing a flow of an eluent system containing organic solvent in a first column and detecting and collecting an eluent fraction containing at least one of said plurality of molecules;
diluting said eluent fraction containing at least one of said plurality of molecules with water while maintaining the solubility of said at least one of plurality of molecules;
transferring said diluted eluent fraction onto a second column containing a stationary phase for purifying said at least one of said plurality of molecules in said sample in said second column wherein said at least one of said plurality of molecules is initially bound to the stationary phase
eluting said second column with organic based eluent wherein said organic based eluent comprises organic solvent at a level of greater than 50% (vol).

22. The method of claim 21 wherein said step of eluting said second column with organic based solvent comprises organic solvent at levels of about 50-100% (vol.).

23. The method of claim 21 wherein said second column includes its own independent pumping system.

24. The method of claim 21 including the step of, prior to eluting said second column, flushing said second column with an eluent to substantially remove from said second column any other solutes or salts that may be present.

25. The method of claim 21 wherein said first column is packed with a substantially uniformly distributed multiplicity of rigid, solid, porous particles with chromatographically active surfaces, so as to form a chromatography column having an interstitial volume between said particles, said particles having average diameters of not less than about 30 μm; and loading said surfaces with said one of a plurality of molecules that is reactive with said surfaces and flowing said eluent system through said column at a velocity sufficient to induce flow of said eluent within at least a substantial portion of said interstitial volume at a reduced velocity greater than about 5,000.

26. The method of claim 21 wherein said second column is packed with a substantially uniformly distributed multiplicity of rigid, solid, porous particles with chromatographically active surfaces, so as to form a chromatography column having an interstitial volume between said particles, said particles having average diameters of not less than about 30 μm; and flowing said eluent system through said column at a velocity sufficient to induce flow of said eluent within at least a substantial portion of said interstitial volume at a reduced velocity greater than about 5,000.
